(19) United States
(12) Patent Application Publication
(10) Pub. No.: US 2014/0309855 A1
(43) Pub. Date: Oct. 16, 2014

(54) SMART CAR WITH AUTOMATIC SIGNALLING

(71) Applicant: Bao Tran, (US)

(72) Inventor: Bao Tran, Saratoga, CA (US)

(73) Assignee: Bao Tran, Saratoga, CA (US)

(21) Appl. No.: 13/862,263

(22) Filed: Apr. 12, 2013

(51) Int. Cl. B60Q 1/34

(52) U.S. Cl. CPC B60Q 1/34
USPC 701/36

(57) ABSTRACT

An intelligent turn signaling system is disclosed which uses trip information and global positioning system data to automatically activate the turn lights for a vehicle. In one implementation, the system can optimize vehicular flow by receiving trip information from nearby vehicles and prepare the vehicle and driver accordingly. In other implementations, the system can also optimize insurance premium for drivers who allow the system to recommend conservative driving techniques.

### BACKGROUND OF THE INVENTION

This invention relates automatic signaling.

As discussed in U.S. Pat. No. 7,173,524, in a motor vehicle, traditional turn signal cancellation is achieved by a mechanism that is imbedded into the vehicle steering column. Initial activation is by hand movement of the turn signal stalk on the left side of the steering column corresponding to the direction of intent. From that point, automatic cancellation is achieved via a ratchet or latch mechanism that is initiated with a physical turning of the steering wheel. When the steering wheel is turned past a designed-in arc angle in the direction of the intended turn, and subsequently returned, a mechanism is tripped to reset the turn signal to the off position. These pre-determined arc angles are designed by the motor vehicle manufacturer and are fixed angle points within the steering column. This is the only means of automatic cancellation of the turn signal function. The turn signal on a vehicle remains active until either manually disabled by the driver or the steering wheel is turned a predetermined amount and returned.

The manual means of turn signal shut off is one of two varieties: one, where the column stalk is physically moved by hand from the turn-signal-on position to the off position by the vehicle operator. The second means is where the vehicle operator initially intends to perform a “lane change”, thereby moving the column stalk from the off position to an intermediate position between turn signal on and turn signal off. This lane change position will hold the turn signal function on as long as the stalk is hand held in that position. Upon hand removal from the stalk, the turn signal is then shut off. This mode is independent of the steering wheel position or movement.

The problem with this art is that the automatic cancel feature responds to steering wheel rotation only, without regard to any other vital vehicle factors related to the execution of a turn. As a result of this information and intelligence deficiency, a turn signal left-on condition is likely and the driver may be unaware of this condition for an extended period of time while driving. Additionally, any degree of normal dither motion of the steering wheel to steer the vehicle through a turn and while the turn signal is on may cause an unintended shut off of the turn signal prior to the actual completion of the intended turn. Still other conditions may exist where automatic turn signal shut off is inappropriate or non-existent. These conditions can create situations while driving that is a nuisance or are a danger.

United States Patent Application 20120166078, whose content is incorporated by reference, discloses a system for providing an externally visible signal regarding a navigational instruction at a vehicle includes a navigation system, a navigation message sender, a navigation message receiver, and a display system. The navigation system generates and outputs turn-by-turn navigational directions within the vehicle to assist a driver of the vehicle in reaching a given destination location. The navigation message sender receives the turn-by-turn navigational directions and transmits them to the navigation message receiver. The navigation message receiver provides a navigational message to the display system for display in a manner visible outside the vehicle.

U.S. Pat. No. 7,173,524, whose content is incorporated by reference, discloses a turn signal control system for turning on and off left and right turn signals in a vehicle. The system includes a computer, such as an antilock braking system computer, with programmed software operably disposed on a vehicle, and a driver interface switch assembly as input to the computer. Sensors transmit angle, differential wheel movement or related data as input to the computer, while a circuit drives turn signal indicator lamps from conditionally computed output data from the computer to turn on and off turn signals in a situation-appropriate manner. Upon turn signal indication intent data input from the driver, extensive travel and turn data is computed, including yaw rotation and steering system position to turn off or cancel the turn signal at the appropriate point.

### SUMMARY

An intelligent turn signaling system is disclosed which uses trip information and global positioning system data to automatically activate the turn lights for a vehicle. In one implementation, the system can optimize vehicular flow by receiving trip information from nearby vehicles and prepare the vehicle and driver accordingly. In other implementations, the system can also optimize insurance premium for drivers who allow the system to recommend conservative driving techniques.

Advantages of the preferred embodiments may include one or more of the following. The system improves automated turn signaling. The system is convenient for drivers and automatically generates turn signals to avoid driver fatigue and to reduce a potentially hazardous driving condition due to an unintentionally maintained-on turn signal. The system reduces cost, size, complexity, wire count and weight in the turn signal mechanical apparatus on the steering column. The system provides an “intelligent” turn signal shut off device which monitors a plurality of vehicle conditions to shut off an unintended “turn signal left on” condition. The system provides a combination of a turn signal device with a four way hazard flasher device in an automobile. The system adapts and adjusts shut off points based upon a driver's recent historical driving habits. The turn signal system is capable of cancellation by a manually operated control. The system functions in both intelligent mode as well as “lane change” mode automatically for the driver. The system can automatically engage 4 way hazard or a modified 4 way hazard for a controlled duration upon activation of a vehicle's anti-lock brake mode. The system can re-activate turn signal function after shut-off if deemed necessary.

### BRIEF DESCRIPTION OF THE DRAWINGS

FIGS. 1A-1C illustrate exemplary block diagram of a smart vehicle.

FIG. 2 shows an exemplary process for automatic signaling.

FIG. 3 is a diagram illustrates generally an insurance rate adjustment component that further includes an analyzer component, according to embodiments as disclosed herein;

FIG. 4 illustrates generally, a method for customizing insurance rates of a driver, according to embodiments as described herein;

FIG. 5 illustrates generally, a method for presenting information related to a real-time insurance rate, according to embodiments as described herein;

FIG. 6 is diagram illustrates generally, a method for installation of a real-time insurance system, according to embodiments disclosed herein;

FIG. 7 is a diagram illustrates generally, a method for gathering information from an on-board monitoring system employed in a real-time insurance system, according to embodiments as disclosed herein;

FIG. 8 is a diagram illustrates generally, a method mounting cameras to capture traffic information, according to embodiments as disclosed herein; and

FIG. 9 is a diagram illustrates generally, a method mounting cameras to capture driver behavior, according to embodiments as disclosed herein.

### DETAILED DESCRIPTION OF THE PREFERRED EMBODIMENTS

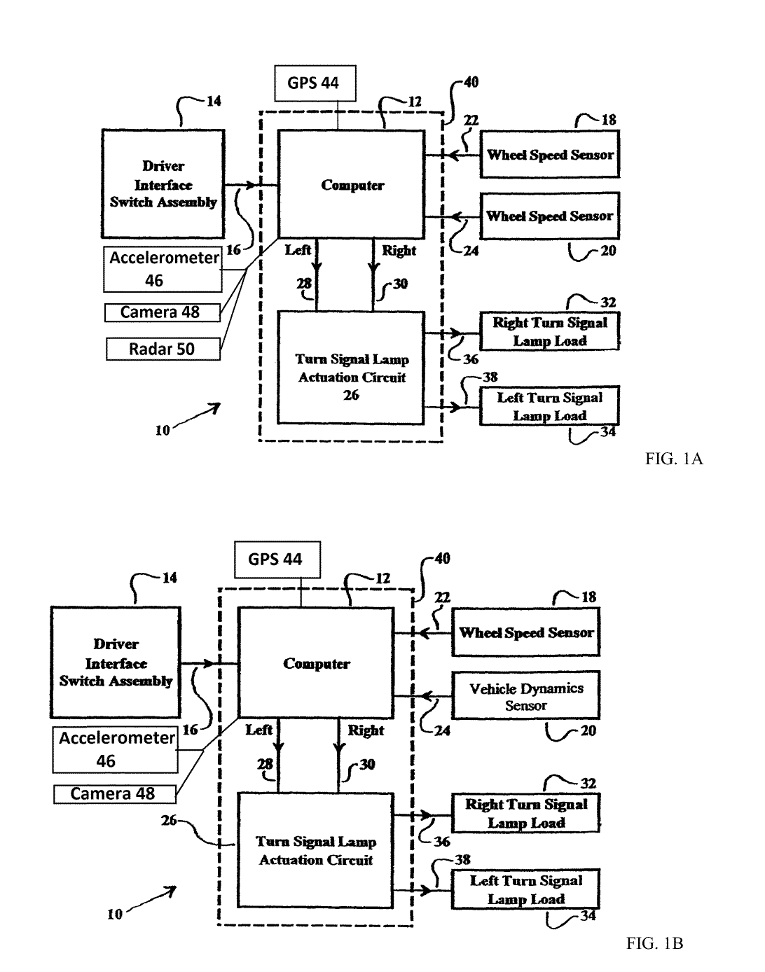

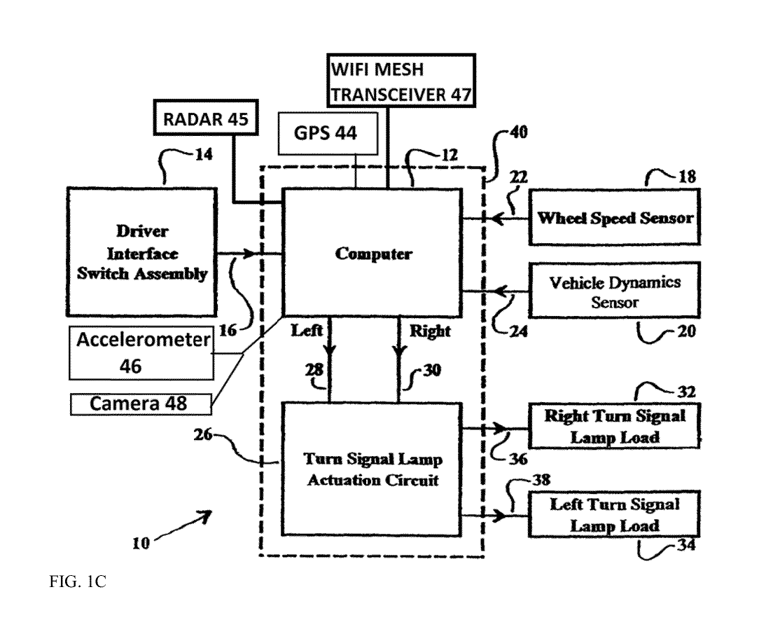

Referring first to FIGS. 1A and 1B, two embodiments of intelligent turn signal control system 10 are shown in function block diagram form. A computer, generally designated by the numeral 12, and can be of the type used in the art having a writeable, non-volatile memory for the storage of long term data and software programs which is operably connected to a vehicle to carry out the functions described herein. This computer 12 is equipped to determine the on/off status of the turn signal based upon inputs and computations. The actual turn signal flashing cycle, typically consisting of a 50% duty cycle on/off and 75 flash cycles per minute may be controlled by the computer 12 as well. The computer 12 receives data from an accelerometer 46, which can be a 3 axis accelerometer. Additionally, a magnetometer and/or a gyroscope can provide information to the computer 12. A camera 46 provides images to the computer 12 and can capture street view information that can be useful for detecting upcoming turns or lane changes. A positioning system 44 supplies position data from satellites such as GLONASS or GPS.

A driver interface switch assembly is designated by the numeral 14. This switch assembly 14 includes function controls for selecting the “right turn signal”, selecting the “left turn signal”, or selecting “cancel” which shuts off all turn signal function. These modes are each achieved by means of a momentary switch that resets to off upon release. Each signal level is considered low current, suited as an input to a computer. Additionally, a four-way hazard mode may be selected within this switch assembly 14. This switch assembly 14 can be an on/off two position switch that holds the function in the on position when switched on. This switch assembly 14 is operably connected to the computer 12 via a electrical connection, designated by the number 16. A form of multiplexing may be used and includes electrical connection 16 to minimize the wire count and wire gauge size for this electrical connection.

Sensors 18, 20 are used to collect and transmit data. In the embodiment of FIG. 1, where numerous wheel speed sensors are used to provide data to the system, the sensors 18 and 20 are wheel speed sensors, and the output signals from them is connected as input to the computer 12 via electrical connections designated by 22 and 24, respectively. In this configuration, the sensors 18 and 20 are of the type commonly used in ABS/traction control systems and are affixed near the vehicle tire/wheel hub within sensing proximity to a rotating multi-toothed wheel, commonly known in the industry as a tone wheel. The output of the sensors 18 and 20 is in the form of an alternating current whose frequency corresponds to wheel speed. In the embodiment of FIG. 1B, where the sensors 18, 20 can be of various types (including, for example, a wheel speed sensor 18 and a vehicle dynamics sensor 20 such as a steering angle sensor, an inertial rotation sensor or an accelerometer), similar connections to that of FIG. 1A can be utilized. In another form (not shown), the wheel speed sensor 18 may instead be configured as a speed sensor whose output measures the vehicle transmission output speed and is mounted at or near the output of the transmission, ahead of the differential gear set.

FIG. 1C shows a system that is similar to FIG. 1C, with the addition of a RADAR sensor 45 and an inter-vehicle wireless transceiver 47. In this case, the transceiver 47 can be a WiMAX system. In another embodiment, the transceiver 47 can be a meshed 802 protocol network configuration with a constantly morphing mobile mesh network that helps drivers avoid accidents, identify traffic jams miles before they encounter them, and act as a relay point for Internet access.

In one embodiment, the mesh network can be the ZigBee mesh network. In another embodiment, the mesh network can be a modified WiFi protocol called 802.11p standard for allowing data exchange between moving vehicles in the 5.9 GHz band. 802.11p operates in the 5.835-5.925 GHz range, divided into 7 channels of 10 MHz each. The standard defines mechanisms that allow IEEE 802.11™ technology to be used in high speed radio environments typical of cars and trucks. In these environments, the 802.11p enhancements to the previous standards enable robust and reliable car-to-car and car-to-curb communications by addressing challenges such as extreme Doppler shifts, rapidly changing multipath conditions, and the need to quickly establish a link and exchange data in very short times (less than 100 ms). Further enhancements are defined to support other higher layer protocols that are designed for the vehicular environment, such as the set of IEEE 1609™ standards for Wireless Access in Vehicular Environments (WAVE). 802.11p supports Intelligent Transportation Systems (ITS) applications such as cooperative safety, traffic and accident control, intersection collision avoidance, and emergency warning.

One variation of 802.11p is called the Dedicated Short Range Communications (DSRC), a U.S. Department of Transportation project as well as the name of the 5.9 GHz frequency band allocated for the ITS communications. More information on the 802.11p standard can be obtained from the IEEE. DSRC itself is not a mesh. It's a broadcast, so it only reaches vehicles within range. Meshing requires a lot more sophistication. There's a routing aspect to it, relaying messages to other nodes. DSRC is much simpler.

One embodiment uses high-powered, heavily encrypted Wi-Fi that establishes point-to-point connections between cars within a half-mile radius. Those connections are used to communicate vital information between vehicles, either triggering alerts to the driver or interpreted by the vehicle's computer. An intelligent car slamming on its brakes could communicate to all of the vehicles behind it that it's coming to rapid halt, giving the driver that much more warning that he too needs to hit the brakes.

But because these cars are networked—the car in front of one vehicle is connected to the car in front it and so forth—in a distributed mesh, an intelligent vehicle can know if cars miles down the road are slamming on their brakes, alerting the driver to potential traffic jams. Given enough vehicles with the technology, individual cars become nodes in a constantly changing, self-aware network that can not only monitor what's going on in the immediate vicinity, but across a citywide traffic grid.

If vehicle dynamics sensor 20 is configured as a steering angle sensor, it can be of the type used in stability control systems and mounted to the steering column. Its output value corresponds to the position of the steering system and is a fixed value for each fixed steering system position from full left turn position to full right turn position. If sensor 20 is configured as an inertial sensor (for example, a yaw rate sensor), then its output value corresponds to the vehicle yaw rotation about the vertical axis of the vehicle. If sensor 20 is configured as an accelerometer, then its output value corresponds to the lateral acceleration of the vehicle as it would experience while in a turn.

A turn signal lamp actuation circuit, designated by the numeral 26, is a circuit that can receive low current computer output signals 28 and 30 and is subsequently capable of driving vehicle turn signal lamp loads, designated by 32 and 34. These lamp loads 32 and 34 are the exterior and instrument cluster turn signal indicator lights that are driven by the turn signal lamp actuation circuit 26 and are connected to the output of the turn signal lamp actuation circuit 26 by electrical connections 36 and 38, respectively.

This system 10 has a distinct and separate circuit for driving both left and right turn signals. It may however be advantageous to combine signals 28 and 30 into one multiplex signal, depending on the proximity of the computer 12 to the turn signal lamp actuation circuit 26. The electrical content of this circuit 26 can be of varied construction. Relay drive, solid state drive, or other means may be employed. Additionally, the flash cycle timing may be created by various means within the turn signal lamp actuation circuit 26.

The system can be integrated with the ABS/traction control system of a vehicle if so equipped. This would be achieved by utilizing the ABS/traction control computer to function as the turn signal computer 12 in lieu of a dedicated computer. Additionally, it is conceivable and practical to integrate the turn signal lamp actuation circuit 26 into the ABS/traction control computer as well, which is depicted in FIG. 1A as dashed line 40. This entails input and output considerations to accommodate the additional functions as compared to conventional ABS. In this scenario, four wheel speed sensors can be employed simultaneously to serve as inputs for both ABS function as well as the turn signal function. A traction control on/off function switch can be incorporated into the driver interface switch assembly 14, thereby reducing the overall wiring complexity on the vehicle. Wheel slip algorithm software can be shared between the turn signal computer software and the ABS/traction control software.

All computations and examples shown herein are for a right hand turn as selected from the driver interface switch assembly 14. Similar computations and on/off modes can be made with respect to a driver selected left hand turn, and those skilled in the art can manipulate versions of that which is illustrated in the present invention to accommodate the algorithm, using the same subsystems of FIGS. 1A-1C and computing for a contrasting, yet equally performing left turn mode.

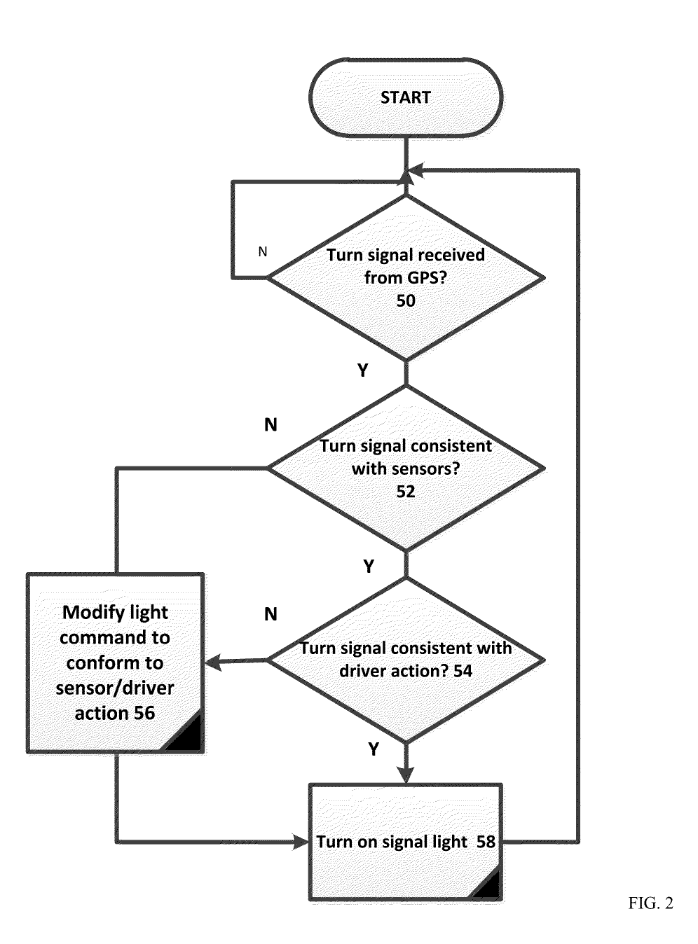

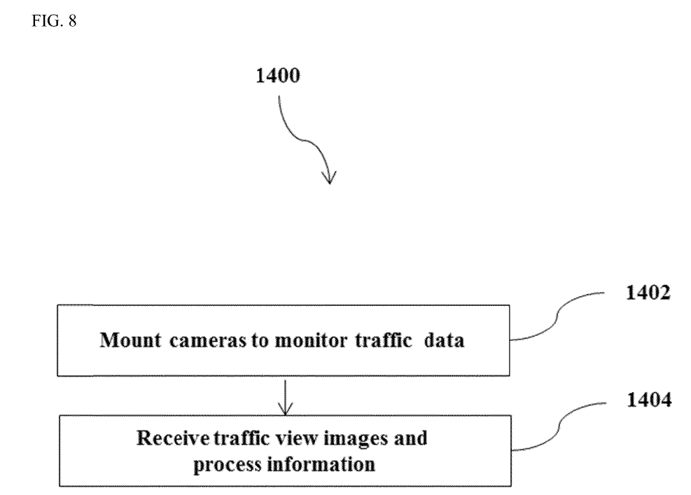

A first embodiment of system 10 (such as that of FIG. 1A) employs a left and a right wheel speed sensor. Although a front and a rear wheel could be utilized for computation purposes to accomplish similar performance results, such as in the case of a motorcycle, the system accuracy is greatly improved by the use of left/right sensing, due to the geometry of most vehicles. The computation examples illustrated in FIGS. 8 through 12 are using separate left and right wheel speed values. A second embodiment of system 10 (such as that of FIG. 2) employs a left rear wheel speed sensor 18 and a vehicle dynamics sensor 20. Mathematical manipulations of these two inputs using the formulas of the present invention can derive a computed value that would represent a signal from the right wheel speed sensor, hence all computed vehicle dynamic values may be made. Further, to limit the amount of error compensation required for non-all wheel drive vehicles, it is preferred that the non-driven wheels in a two wheel drive vehicle would be used. Such is the case in a front wheel drive vehicle with the primary turn signal sensing occurring at the rear wheels. The present invention can, by programming of the computer 12, accommodate all vehicle variations such as full time all wheel drive vehicles, part time four wheel drive vehicles, four wheel steer vehicles, long wheel base buses, or heavy duty trucks.

Turn signal control is, as stated, controlled by specific software computations in combination with external inputs to the computer 12. The initialization point is defined as the point when the turn signal on mode is selected at the driver interface switch assembly 14, and where all values start at zero. Where used for computational purposes, maximum and minimum values are defined and established continuously starting from the initialization point and are reset when the turn signal is shut off.

Not shown in FIG. 1A-1C is a steering device that is used to steer the vehicle, and a turn signal activation system. The steering device may be a steering wheel, a handle, lever, joystick, button(s), foot pedals, stick, or the like. The turn signal activation system includes a turn signal activator in communication with the computer 12, which may be a microchip or other such processor. The turn signal activator may be a button, lever, stick, or any other such device that may be engaged in order to activate the turn signal (i.e., allows a signal to be sent to the processing unit of computer 12). In one embodiment, the turn signal activation system also includes a clock/timer, a velocity sensing device, such as used in conjunction with a speedometer, a distance measuring device, such as used in conjunction with an odometer that is configured to measure the distance the vehicle travels, and a positional sensor, which may be a gyroscope or another device that may be in communication with a global positioning system (GPS). The velocity sensing device may measure the velocity of the vehicle by measuring the rate of rotation of a wheel, while the distance measuring device may correlate distance traveled to the number of rotations of the wheel. The velocity sensing device may also sense velocity of the vehicle based on revolutions per minute (RPMs) within the engine of the vehicle, which are typically indicated by a tachometer. The timer, the velocity sensing device, the distance measuring device, and the positional sensor are all in communication with the computer 12, either through wired, or through wireless connections.

Certain embodiments of the present invention use the measured velocity of a vehicle to determine when to activate or deactivate a turn direction indicator. In operation, the computer 12 determines the velocity of the vehicle by way of the velocity sensing device. Once the GPS activates the turn direction indicator to display a turn signal (such as by a flashing light on a turn signal indicator), the computer 12 then activates the turn signal indicator(s) of the vehicle to display a turn signal. Additionally, the computer 12 temporarily stores, in memory, a data point representing the magnitude of the velocity, i.e., speed, of the vehicle at the moment the turn signal activator is engaged, or at a time just prior to the engagement of the turn signal activator.

As the vehicle turns, the velocity of the vehicle changes by virtue of the turn itself. Typically, as a vehicle turns, the magnitude of its velocity, i.e., speed, decreases and this is used by the computer 12 to infer that the user is following the turn-by-turn instruction from the GPS or not. Thus, if the GPS turn-by-turn instruction is telling the driver to turn right and yet the driver's the velocity and heading of the vehicle is not slowing down and camera images indicate that the driver is changing lane to the left, the system infers that the user is ignoring the GPS instruction and thus disables the light signaling command and vice versa. The computer 12 continues to monitor the velocity of the vehicle through the velocity sensing device during the turn. The computer 12 deactivates the turn signal indicator(s) of the vehicle after the magnitude of the velocity reaches a predetermined fraction or percentage of the stored velocity data point. For example, the computer 12 may deactivate the turn signal indicator(s) once the speed of the vehicle is within 80% of the stored velocity data point. Optionally, various other predetermined percentages may be used by the processing unit 18 to trigger deactivation of the turn signal indicator(s).

In another embodiment of the present invention, the computer 12 computes a predetermined “minimum” speed of the vehicle once the turn signal activator is engaged. For example, once the turn command is received from the mapping system and the GPS, the computer 12 stores a speed data point that is a fraction or percentage, for example 80%, of the instantaneous speed of the vehicle at the moment the turn is suggested. The computer 12 continues to monitor the velocity of the vehicle through the turn. After the speed of the vehicle drops below the predetermined minimum speed represented by the stored speed data point, and subsequently rises above the stored speed data point, the computer 12 deactivates the turn signal displayed on the turn signal indicator(s).

In still another embodiment, a turning distance data point is stored within the memory of the computer 12. The turning distance data point may be a measure of distance traveled by a vehicle that equals the distance of a “normal” turn. For example, a normal turn from a vehicle heading in a North direction to a West direction may be a certain number of feet or meters of distance (or number of revolutions of a wheel), which is detected by the distance measuring device or odometer. Once the turn signal activator is engaged, the processing unit detects the distance traveled by the vehicle through the distance measuring device such as an odometer. When the distance traveled by the vehicle matches or exceeds the turning distance data point, the computer 12 deactivates the turn signal displayed on the turn signal indicator(s).

In yet another embodiment of the present invention, a turning time data point is stored within the memory of the computer 12. The turning time data point may be a measure of time a vehicle typically takes to make a normal turn. For example, a normal turn from a vehicle heading in a North direction to a West direction may take a certain number of seconds. Once the turn signal activator 16 is engaged, the computer 12 detects the actual turn time of the vehicle through the timer 20. When the actual turn time of the vehicle matches or exceeds the turning time data point, the computer 12 deactivates the turn signal displayed on the turn signal indicator(s).

The computer 12 may use data collected from each of a timer, the velocity measuring device, the distance measuring device, the positional sensor, magnetometer, gyroscope, or accelerometer, alone, or in combination with one another to determine when to deactivate a turn signal. Additionally, in the event that the vehicle comes to a complete stop after the turn signal activator 16 is engaged, the computer 12 continues to maintain displaying the turn signal. Optionally, the turn signal sequence may be interrupted while the vehicle is stopped, and resumed upon movement of the vehicle.

The computer 12 may be in communication with the positional sensor 44, which in turn may be communication with a satellite of a global positioning system (GPS). Turning directions, speed, and the like may be determined through the positional sensor and/or the GPS. That is, the computer 12 may receive heading signals (e.g., North or South) from the positional sensor and/or the GPS. The computer 12 may then determine when a turn is complete through these signals. For example, the computer 12 may determine that the vehicle has made a complete turn based on orientation data, e.g., directional heading, received from the positional sensor, which may be a compass, gyroscope or the like. The computer 12 may be configured to determine that a turn has been completed when the heading of the vehicle is 90 degrees different from an initial heading. The initial heading may be stored in memory as a data point when the turn signal is first activated. The computer 12 then compares the heading of the vehicle to the initial heading. When the heading of the vehicle is 90 degrees different from the initial heading, the computer 12 deactivates the turn signals. Optionally, the computer 12 may be configured to determine the completion of a turn when an initial heading differs from a later heading by more or less than 90 degrees.

Additionally, the positional sensor may transmit a signal to a GPS, which may then transmit a positional signal back to the computer 12 indicating the vehicle's position, heading and/or speed. The computer 12 may then use this information to determine when a turn is complete. For example, the computer 12 may determine that a full turn is complete through data received from the GPS indicating that the heading of the vehicle has changed from one direction, e.g., North, to a second direction, e.g., West.

Additionally, the computer 12 may be configured to distinguish between a regular turn, and a “lane change”, or “lesser” turn, which is not a full turn. For example, if a vehicle operator wishes to make a full turn, the user engages the turn signal activator for a predetermined time indicative of a full turn, which is detected by the computer 12. If, however, the operator merely wants to signal a lane change, the operator engages the turn signal activator for another predetermined time indicative of a lesser turn. For example, the user may engage the turn signal activator for three seconds to initiate the signaling of a full turn, while the turn signal activator may be engaged for one second to initiate signaling of a lesser turn. Further, the turn signal activation system may include separate turn signal activators for full and lesser turns. For example, the system may include a partial activation switch configured for a lane change signal. The computer 12 may deactivate a signal for a lesser turn after a predetermined time or distance, due to the fact that the speed of the vehicle may not change appreciably during the lesser turn.

Prior to operation, the operator may calibrate a full turn engagement of the activator and a lesser turn. That is, the driver may set the time for a full turn by engaging the turn signal activator for a first period of time; and he/she may also set the time for a lesser turn, such as a lane change, by engaging the turn signal activator for a second period of time. Setting or calibrating the turn signal activator may be initiated by the operator engaging the activator an amount of time programmed into the computer 12. For example, the computer may be adapted to recognize that engagement of the activator for 7 seconds initiates a full turn set-up process, while an engagement of the activator for 10 seconds initiates a lesser turn set-up process. Optionally, the set-up process may be initiated by the operator repeatedly switching the activator ON and OFF for a predetermined period of time and/or by a specific sequence of events, such as by first switching the activator ON, then turning the lights on, and the like.

A vehicle's speed during a turn is typically slower than at a time just before the vehicle turns. If, the sample RPM is less than the working RPM, then the computer 12 continues to check to see at which point the sample RPM is greater to or equal to the working RPM of the vehicle and continues to display the turn signal. If, however, the sample RPM is less than the working RPM of the vehicle (i.e., the vehicle is traveling at a higher speed than when the sample reading was taken—the vehicle is completing, or has completed, a turn), the processor deactivates the turn signal.

At any time during operation, the operator may deactivate the auto turn signal deactivator. That is, the operator may prefer to manually deactivate the turn signal. Such deactivation of the auto turn signal deactivator may be accomplished by way of a toggle switch, extended engagement of the turn signal activator, or various other methods.

Thus, embodiments of the present invention provide a system and method of automatically activating or deactivating a turn signal. In particular, certain embodiments of the present invention do not rely on a mechanical trigger to deactivate the turn signal.

The system provides for an intelligent turn signal control that is aware of many vital vehicle conditions and therefore provide for situation appropriate control of the turn signal system. In addition to the examples of techniques defined herein, sufficient information is derived from the driver interface switch assembly 14 and cameras, GPS, accelerometers, magnetometers, gyroscopes, and wheel speed sensors to refine and enhance full operation of an intelligent turn signal control. The turn signal has two distinct modes: Lane change and fully automatic. Both of these modes are attained with the same driver interface switch assembly 14 in combination with the computer 12 to recognize the input desired via the electrical connection.

During operation, the computer 12 receives turn-by-turn navigational directions from the GPS and mapping software which may be stored in memory of the computer or may run from a cloud server. Turn-by-turn navigation directions may contain a specified action (e.g. turn right/left, go on, exit right/left, u-turn, etc.), an immediate destination (e.g. Fifth Ave, US HWY 101, Exit 89B), and/or a distance to a location where the action should be taken (e.g. 100 m, 4 miles). The light actuator 26 receives the turn command and displays the command in a textual and/or visual representation. In one embodiment, in addition to the lights on the left/right sides of the vehicle, an LED display and speaker can be placed on the vehicle to communicate multimedia messages. If the LED display has a text character limitation, a message transformation is used, for example, if the original navigational message is too long to fit into the display screen. For example, if the original message is “Escuela Avenue” it can be transformed into “Escuela Ave.” In addition, if the transformed message is still too long to fit into the display screen, animation display techniques may be utilized for effective display. For example, a text rotation technique wherein the displayed message is continuously shifted one letter by one letter towards left or right over time may be used.

The system can be manually controlled so that, when a user signals a turn, the system signals which turn will be taken, but when the user is not signaling a turn, no navigational message is displayed. This optional feature helps to avoid display of a false navigational message signal that might otherwise occur if the navigation system provides a navigation instruction that the driver chooses to ignore.

A process for displaying turn signaling is shown in the flow chart of FIG. 2. The process begins at stage 50, wherein the computer 12 determines whether a turn signal has been received from the GPS turn by turn command. If a turn signal has been received, the process flows to stage 52, wherein the computer 12 determines whether the received turn signal is consistent with vehicle sensor data. For example, if sensors detect that the vehicle is slowing down and aiming left, and the current navigational instruction is to take a left turn on HWY X, then the sensor output and navigational instruction may be deemed consistent. On the other hand, if a left turn is detected and the current navigational instruction is to bear right on Exit 1, then the turn signal and navigational instruction may be deemed inconsistent. If so, the process modifies the light display to conform to actual vehicle heading as detected by the sensors or by driver action (such as manually turning the left/right lights) in stage 56. From 52, if the sensor data is consistent, the process checks for consistency with the driver action (such as slowing down or activating a light indicator) in 54. For example, if a left turn signal is received, and the current navigational instruction is to take a left turn on HWY X, then the turn signal and navigational instruction may be deemed consistent. On the other hand, if a left turn signal is received and the current navigational instruction is to bear right on Exit 1, then the turn signal and navigational instruction may be deemed inconsistent. If at stage 54 it is determined that the received turn signal is consistent with a current instruction of the system, then the appropriate light is turned on at stage 58. Otherwise, the process returns to stage 50 to process the next turn-by-turn command.

Utilizing the wheel speed data from two or more wheels and the inherent data differential thereof, software programmed in the computer is used to conditionally compute appropriate turn signal shut-off points.

Upon actuation of a turn signal from the driver interface switch, the software is capable of compiling sensor data to determine valuable vehicle condition states, including vehicle yaw rotation, distance, speed, acceleration, arc turn radius, lateral acceleration, time and steering wheel angle. The data are conditionally computed to determine the appropriate shut off point of the turn signal, thus eliminating a premature shut off as well as a turn signal left on.

The process detects the duration of the turn signal lever actuation as input from the driver interface switch assembly, discerning by short or long duration of the turn signal switch whether the driver intends a full self-cancel mode turn signal or intends a “lane change” based on the driver actuation as well as the camera output. If a long duration of the switch is made, a “lane change” is called for and the turn signal is shut off upon release of the switch. If a short duration of switch actuation is made, then the self-cancel mode is indicated, then the software monitors vehicle velocity data inputs to determine whether the vehicle's velocity has dropped below a predetermined amount or whether wheel slippage is detected. If yes, the software applies a second set of rules which are better suited to an error potential condition and is discussed hereinafter. If no, software compiles a signal accumulated differential data pulse count indicative of the vehicle's relative distance traveled for a left tire and a right tire. This function determines total vehicle yaw rotation angle and then subsequently determines whether it has crossed a conditionally computed threshold vs. percentage velocity increase from local velocity minimum of the vehicle. If yes, the computer transmits an off signal to the turn-signal lamp actuation circuit, indicative of a sufficient vehicle yaw rotation for complete execution of the turn. The software further calculates the real-time frequency ratio between left and right tires, computing a value that directly corresponds to real-time steering wheel position. The software computes a ratio for percentage of steering wheel returning from maximum steering wheel rotation excursion and compares it to a percentage velocity increase from local minimum. Upon exceeding a conditionally computed threshold, the computer transmits an off signal to the turn-signal lamp actuation circuit, indicative of a steering wheel returning towards a straight ahead position. In another embodiment, the camera output is used to determine completion of the turn.

Further, if an extended straight-line travel has occurred as detected by the camera and the accelerometer and the vehicle has maintained a near steady state velocity, then a conditionally computed threshold will be exceeded whereby then the software transmits a turn signal off signal to the turn signal lamp actuation circuit, canceling an inadvertent turn-signal-left-on condition.

The software further detects if the opposite turn signal is activated, that is if right turn signal mode is on, and then a left turn is initiated as detected by the accelerometer and camera and GPS, the software instantly cancels the right turn mode and commences a left turn signaling process, and vice versa.

Further, if the software detects that the driver has activated a four way flasher mode, then all turn signal function and computations are overridden and both right and left turn signals are simultaneously activated, emulating a four way flasher mode. The system is constructed such that this mode may be selected with or without the ignition on.

The software can “learn” a driver's turn signal usage habits, based upon inputs from both the driver interface switch assembly and the wheel speed inputs and then adapt the conditional computations to create more accurate shut off points for subsequent turns.

The computer 12 can receive input from the vehicle's Antilock Braking System (ABS). When the ABS is actuated to modulate the vehicle's brakes, the four way flashers can be actuated at a standard or a modified flash frequency to alert other drivers of the vehicle's extreme braking condition.

The function of four way hazard flashers can be incorporated into the system function, integrating especially well when the turn signal computer 12 is part of the ABS system. If the antilock braking system is activated due to a maximum braking mode reached by the vehicle, in addition to modulating brake function, the computer 12 could activate both the left and the right turn signals at normal flashing cycle speed or at a faster than normal flash speed. This would have the effect of alerting other drivers in all directions that an extreme braking condition is occurring. Upon the ABS ceasing the brake modulation function on the vehicle, the flashers would cease as well. This passive safety feature has the potential to prevent an accident and may be added for minimal or no cost.

Cruise control may be an input to the turn signal computer 12. Upon actuation of the turn signal with the cruise control on, the duration of the driver interface switch assembly calling for a turn signal mode would be ignored. The turn signal would be held on for a fixed length of time, e.g. 4 seconds, indicating a lane change mode during a steady state speed condition. Although this is a possibility, it may not necessarily be cost effective to incorporate the information from the cruise control to enhance the overall performance.

Performing a service function is made easier as well. If a replacement of the driver interface switch assembly is required, vehicle manufacturers can design for ease of service without compromising the design. Diagnostics built into the computer 12 can serve to alert where failures are occurring or have occurred, such as bulb failure, or switch failure. In the event of a wheel speed sensor 18 or 20 failure, the computer 12 could detect the failure and subsequently use the input from another functioning wheel speed sensor, one previously unused for turn signals. This would retain full function of the intelligent turn signal function. Durability of the system may be improved as well due to the simplicity of the switching in the current invention.

The current invention is intended to comply with all Federal Motor Vehicle Safety Standards, specifically FMVSS 108, pertaining to vehicle lighting, and FMVSS 105 and 135, pertaining to braking systems. Additionally, the current invention is intended to comply with current Society of Automotive Engineers' standards and recommended practices pertaining to lighting and braking.

The system may be implemented in hardware or software depending upon the usage environment. In a hardware embodiment, the components of the system other than the display system are implemented as one or more dedicated integrated circuits (ICs) or circuit assemblies. In the case of separate ICs, the components may communicate wirelessly or via hard-wired interconnections. Generally, if those components of the system are implemented as a single assembly, or at least one component of the system, if those components of the system are implemented via separate ICs, will embody a processor to execute the functions of the system.

In a software embodiment, the components of the system other than the display or lights are implemented as software components or modules, residing on one or more processor-equipped devices or units, e.g., the in-vehicle telematics unit or otherwise. It will be appreciated that in an embodiment wherein the described functions are software driven, such functions are executed via the computerized execution, by the processor, of computer-executable instructions stored on a tangible non-transitory computer-readable medium such as an optical, magnetic, or flash drive, or a PROM, EPROM, etc.

Wireless interconnections may be used in various embodiments or between other components of the system. In these embodiments, such wireless interconnections may be transient or permanent, and may be via any suitable protocol, e.g., BLUETOOTH, ZIGBEE (or other 802.15x), 802.11x, etc.

The vehicle can have a camera coupled to the processor to a capture street view. The processor stores images captured by the camera and uploads the images and location data to a server collecting street view data from a collection of drivers, wherein the server runs code for crowd-sourcing the street views to generate a mapping system. A radar can communicate with the processor to detect nearby obstacles. The vehicle can have built-in a gyroscope or a magnetometer that provides driving information to the processor. Other sensors can include vehicle speed sensor to measure wheel rotation, transmission rotation. Based on the detected driving behavior and if a hazardous condition is encountered such as fog report from a weather station over the internet or from the police authority or from other users, the processor simultaneously switches left and right turn signals on and off to emulate a hazard function. The computer activates the turn signal lamp actuation circuit upon activation of a vehicle anti-lock braking system. The processor can be programmed to monitor a vehicle cruise control function to determine turn signal operational status. The driver interface switch assembly can have at least one redundant turn signal actuation control disposed on a steering wheel. The processor prepares vehicular brakes for a detected turn or an anticipated turn.

In one embodiment, the processor receives travel routes and sensor data from adjacent vehicles, such information is then used for preparing vehicular brakes for a detected turn or an anticipated turn from adjacent vehicles. The travel routes can be transmitted over a vehicular WiFi system that sends protected information to nearby vehicles equipped with WiFi or Bluetooth or Zigbee nodes. In one embodiment, a mesh-network is formed with WiFi transceivers, wherein each vehicle is given a temporary ID in each vehicular block, similar to a cellular block where vehicles can join or leave the vehicular block. Once the vehicle joins a group, travel routes and sensor data is transferred among vehicles in a group. Once travel routes are shared, the processor can determine potential or desired actions from the adjacent vehicles and adjust appropriately. For example, if the car in front of the vehicle is about to make a turn, the system prepares the brakes and gently tugs the driver's seat belt to give the drive notice that the car in front is about to slow down. In another example, if the processor detects that the driver is about to make a lane change to the left based on sensor data and acceleration pedal actuation, but if the processor detects that the vehicle behind in the desired lane is also speeding up, the system can warn the driver and disengage the lane change to avoid the accident. Thus, the processor receives travel routes and sensor data from adjacent vehicles and notifying the driver of a detected turn or an anticipated turn from adjacent vehicles. The processor receives travel routes and sensor data from adjacent vehicles and optimizes group vehicular speed to improve fuel efficiency. The processor receives travel routes and sensor data from adjacent vehicles and sequences red light(s) to optimize fuel efficiency. The processor notifies the driver of driving behaviors from other drivers at a predetermined location. The processor switches turn signals and brakes using a predetermined protocol to reduce insurance premium for the driver. The processor warns the driver to avoid driving in a predetermined pattern, driving during a predetermined time, driving in a predetermined area, or parking in a predetermined area to reduce insurance premium for the driver. The processor sends driver behavior data to an insurer, including at least one of: vehicle speed, vehicle accelerations, vehicle location, seatbelt use, wireless device use, turn signal use, detection of ethanol vapor, driver seating position, and time.

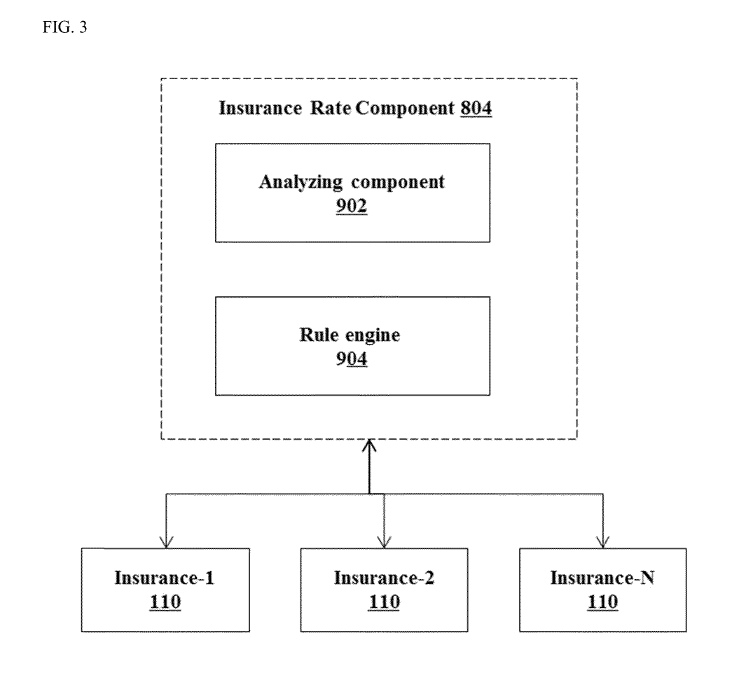

The processor provides insurance premium reduction feedback to the driver based on the at least one parameter associated with the driver behavior. FIG. 3 is a diagram 900 illustrates generally, the switching component 806 that further includes an analyzer component 902, which further employs threshold ranges and/or value(s) (e.g., pricing ranges for insurance policies, terms of the insurance policy, and the like) according to a further aspect of the present invention. The analyzer component 902 can be configured to compare a received value for insurance coverage to the predetermined thresholds, which can be designated by an owner/driver. Accordingly, the analyzer component 902 can determine if the received insurance coverage policies are within the desired range as specified by a user an “accept” or “reject”, and/or further create a hierarchy from “low” to “high” based on criteria designated by the user (e.g., price of the insurance policy, terms of the insurance policy, and the like).

According to a further aspect, the analyzer component 902 can further interact with a rule engine component 904. For example, a rule can be applied to define and/or implement a desired evaluation method for an insurance policy. It is to be appreciated that the rule-based implementation can automatically and/or dynamically define and implement an evaluation scheme of the insurance policies provided. Accordingly, the rule-based implementation can evaluate an insurance policy by employing a predefined and/or programmed rule(s) based upon any desired criteria (e.g., criteria affecting an insurance policy such as duration of the policy, number of drivers covered, type of risks covered, and the like.).

In a related example, a user can establish a rule that can implement an evaluation based upon a preferred hierarchy (e.g., weight) of criteria that affects the insurance policy. For example, the rule can be constructed to evaluate the criteria based upon predetermined thresholds, wherein if such criteria does not comply with set thresholds, the system can further evaluate another criteria or attribute(s) to validate the status (e.g., “accept” or “reject” the insurance bid and operate the switching component based thereon). It is to be appreciated that any of the attributes utilized in accordance with the subject invention can be programmed into a rule-based implementation scheme.

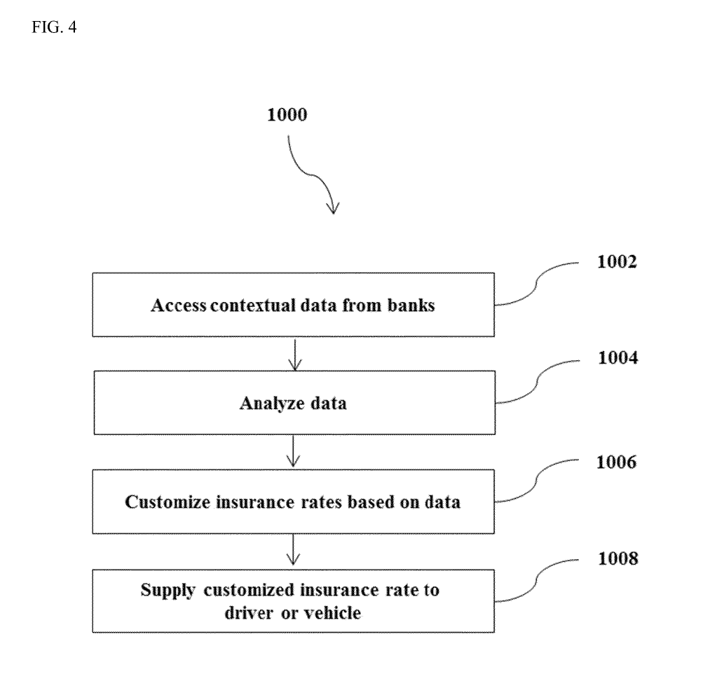

FIG. 4 illustrates generally, a method 1000 for customizing insurance rates of a driver, according to embodiments as described herein. The methodology 1000 of customizing insurance rates according to a further aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 1002 contextual data from various data banks can be accessed by the insurance providers or supplied thereto. As explained earlier, the data banks can include data pertaining to the motor vehicle (e.g., maintenance history, current vehicle conditions, and the like), data related to the driver (e.g., via health insurance records, police records, internet records, and the like), and data related to operating environment (e.g., weather, geographical location, and the like.) Moreover, the real-time contextual driving data can include both an intensity portion and a frequency portion, which represent severity and regularity of driving episodes (e.g., slamming the brakes, gradual/sudden deceleration, velocity variances, and the like). Subsequently and at 1004, such data can be analyzed by the insurance providers as to customize an insurance rate based thereon at 1006. In an embodiment, insurance rate can be calculated in real-time and as such can more accurately reflect appropriate coverage for a situation of a driver. A plurality of different factors can influence a likelihood of the driver being involved in an accident, having a vehicle stolen, and the like. For example, if the driver is travelling through bad weather, then risk can be higher and a rate can be increased in real-time as weather conditions change-conversely, if there is relatively little traffic surrounding the driver's vehicle, then the rate can be lowered. An algorithm or complex model can be used to calculate the insurance rates and can be disclosed to the driver through the display. In an embodiment, the rate adjustment component 804 can be configured to evaluate the insurance rate information against current vehicle operation by the driver. Specifically, the evaluation can compare the current operation against insurance rate information to determine if an appropriate rate is being used, if the rate should be changed, what the change should be, etc. For instance, different aspects of vehicle operation can be taken into account such as for example, but not limited to, weather and how a driver reacts, speed (of a vehicle), traffic and how the driver reacts, and noise {e.g., radio level), and the like.

Subsequently, the customized insurance rate can then be sent from an insurance provider to an owner/driver of the vehicle (e.g., in form of an insurance bid) at 1008. For example, the insurance rate can be determined and represented upon the driver via the display or controller in the vehicle. A processor that executes the computer executable components stored on a storage medium can be employed. In an embodiment, the monitoring unit can communicate with an insurance company (e.g., continuous communication) and obtain an insurance rate directly. The system can be configured to customize the insurance based on the obtained insurance rates and present to the driver and make appropriate modification to the display automatically.

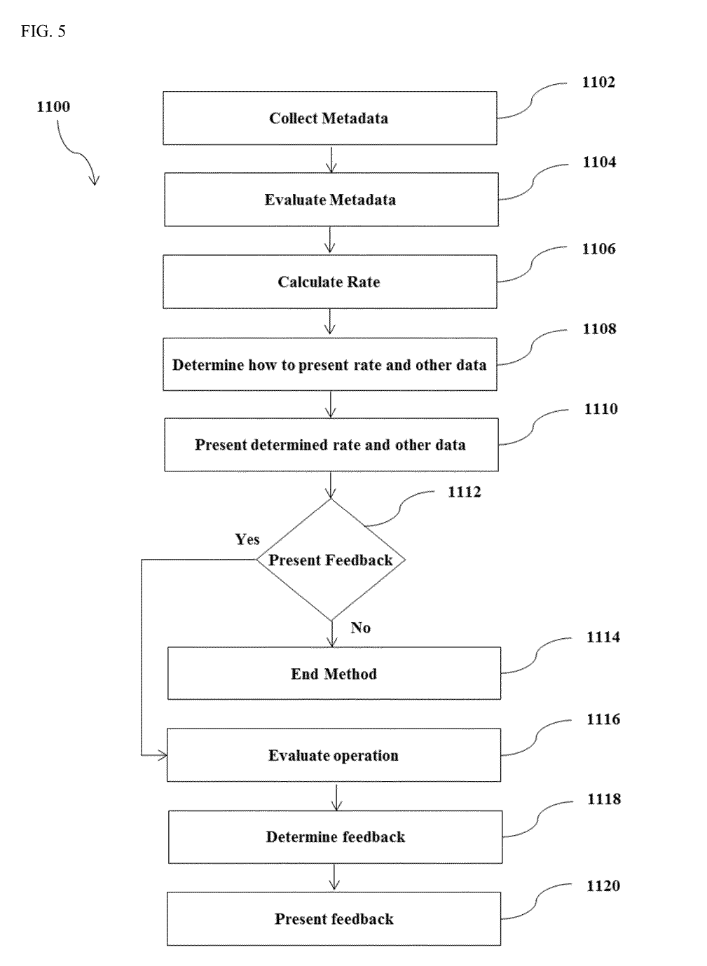

FIG. 5 illustrates generally, a method 1100 for presenting information related to a real-time insurance rate, according to embodiments as described herein. In an embodiment, at 1102, Metadata can be collected pertaining to real-time operation of a vehicle and at least a portion of the metadata can be evaluated, as shown at 1104. The metadata described herein can include driver behavior data, contextual information, driver history, and real-time driving information that relates to operation of a driver and vehicle, and the like. Based upon a result of the evaluation, there can be calculation a real-time insurance rate, such as shown at 1106.

In an embodiment, at 1108, determination can be made on how to present the calculated rate. For example, the determination can be if the rate should be shown on a center console or a heads-up display. A determination can also be made on how to display data (e.g., if a numerical rate should be disclosed or a color element should be lit). Additionally, a determination can be made on other data to disclose, such as safety, environment impact, cost of operating vehicle, a target speed, group rank, and the like. The determined rate and other determined data can be presented through a display, such as shown at 1110. Thus, the determined rate is presented upon a display viewable to the driver of the vehicle.

In an embodiment, at 1112, the method 1100 includes determining if feedback should be presented to the user. The feedback can be supplied in real-time as well as be a collective summary presented after a driving session is complete. If no feedback should be presented, then the method 1100 can end at 1114. In one instance, if there is a new driver attempting to obtain a full drivers license (e.g., teenage driver) or newer driver, then the check 1112 can determine feedback should be automatically provided. In another embodiment, an operator can be solicited on if feedback should be presented depending on a response the method 1100 can end or continue.

Operation of the vehicle and driver can be evaluated at 1116, which can occur though different embodiments. As a user operates a vehicle, metadata can be collected and evaluated in real-time. In an alternative embodiment, data can be collected, but evaluation does not occur until the check 1112 determines feedback should be presented. At 1118, there can be determining feedback for suggesting future driving actions for the operator to perform in future driving to lower the insurance rate. The method 1100 can include presenting the feedback (e.g., through the display, through a printout, transferring feedback as part of e-mail or a text message, etc.) at 1120. The feedback can be directly related to a driving session as well as is an aggregate analysis of overall driving performance (e.g., over multiple driving sessions).

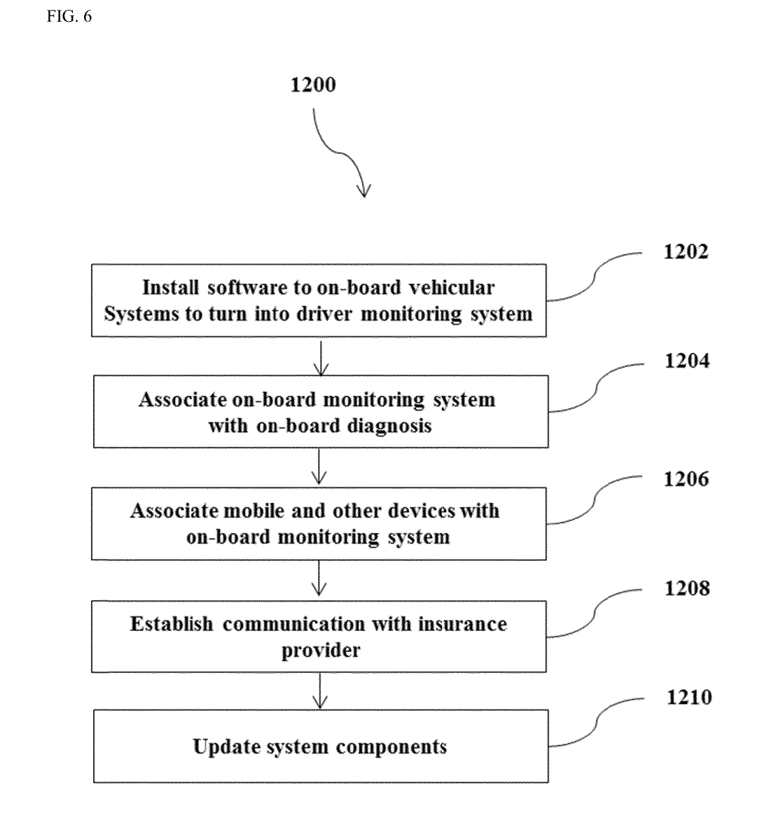

FIG. 6 is diagram illustrates generally, a method 1200 for installation of a real-time insurance system, according to embodiments disclosed herein. In an embodiment, at 1202, an on-board monitoring system (such as driver monitoring unit) 102 is installed in a vehicle to facilitate the collection of real-time data from the vehicle and forwarding of the real-time data to an insurance provider. At 1204, the on-board monitoring system can be associated with the on-board data/diagnostic control units and system(s) incorporated into the vehicle. The on-board data/diagnostic control units and system(s) can include the vehicles engine control unit/module (ECU/ECM), transmission control unit (TCU), power train control unit (PCU), on-board diagnostics (OBD), sensors and processors associated with the transmission system, and other aspects of the vehicle allowing the on-board monitoring system to gather sufficient data from the vehicle for a determination of how the vehicle is being driven to be made. The on-board monitoring system can be communicatively coupled by hard wiring to the on-board diagnostic system(s) or the systems can be communicatively associated using wireless technologies.

In an embodiment, at 1206, a mobile device (e.g., a cell phone) can be associated with the onboard monitoring system where the mobile device can facilitate communication between the on-board monitoring systems with a remote insurance provider system. The mobile device provides identification information to the on-board monitoring system to be processed by the on-board monitoring system or forwarded an insurance provider system to enable identification of the driver.

In an embodiment, at 1208, communications are established between the on-board monitoring system and the mobile device with the remote insurance provider system. In one embodiment it is envisaged that the on-board monitoring system and the insurance provider system are owned and operated by the same insurance company. However, the system could be less restricted whereby the insurance provider system is accessible by a plurality of insurance companies with the operator of the on-board monitoring system, e.g., the driver of the vehicle to which the on-board monitoring system is attached, choosing from the plurality of insurance providers available for their particular base coverage. In such an embodiment, upon startup of the system the insurance provider system can default to the insurance company providing the base coverage and the operator can select from other insurance companies as they require.

Over time, as usage of the on-board monitoring system continues, at 1210, there is a likelihood that various aspects of the system might need to be updated or replaced, e.g., software update, hardware updates, etc., where the updates might be required for an individual insurance company system or to allow the on-board monitoring system to function with one or more other insurance company systems. Hardware updates may involve replacement of a piece of hardware with another, while software updates can be conducted by connecting the mobile device and/or the on-board monitoring system to the internet and downloading the software from a company website hosted thereon. Alternatively, the software upgrade can be transmitted to the mobile device or the on-board monitoring system by wireless means. As a further alternative the updates can be conferred to the mobile device or the on-board monitoring system by means of a plug-in module or the like, which can be left attached to the respective device or the software can be downloaded there from.

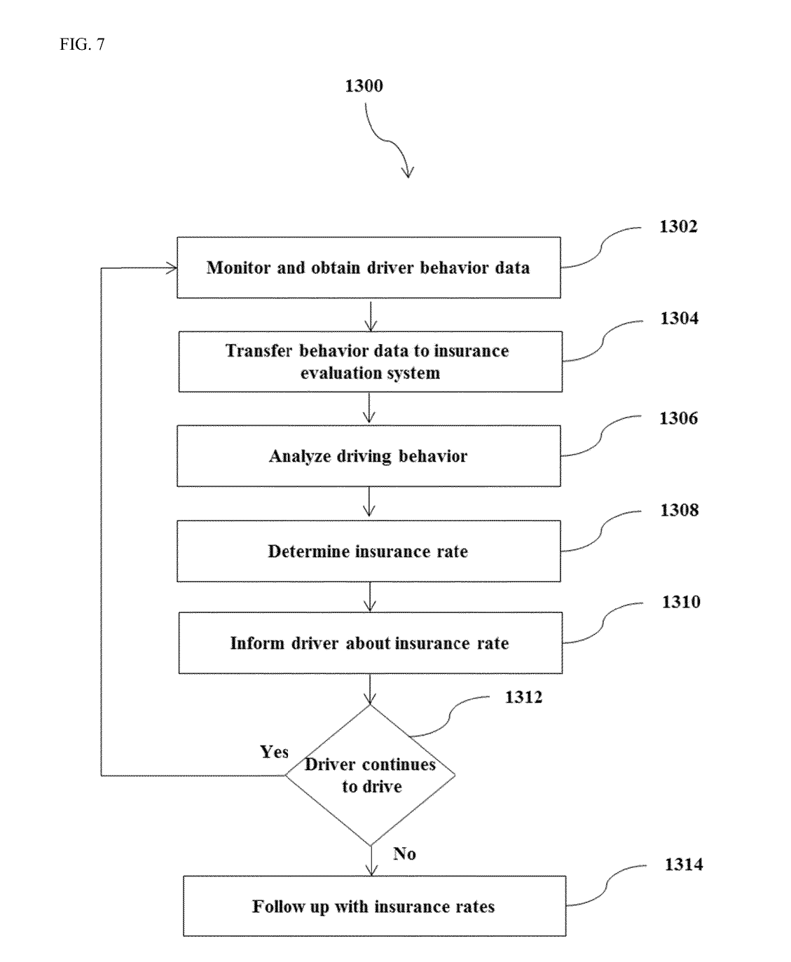

FIG. 7 is a diagram illustrates generally, a method for gathering information from an on-board monitoring system employed in a real-time insurance system, according to embodiments as disclosed herein. In an embodiment, at 1302, monitoring of the driver and the vehicle they are operating is commenced. Monitoring can employ components of an on-board monitoring system, mobile device components, e.g., cell phone system, or any other system components associated with monitoring the vehicle as it is being driven. Such components can include a global positioning system (GPS) to determine the location of the vehicle at any given time, such a GPS can be located in a cell phone, as part of the on-board monitoring system, or an external system coupled to the monitoring system/cell phone—such an external system being an OEM or after sales GPS associated with the vehicle to be/being driven. A video data stream can be gathered from a video camera coupled to the on-board monitoring system recording the road conditions, etc. throughout the journey. Information can also be gathered from monitoring/control system(s) that are integral to the vehicle, e.g., the vehicle's engine control unit/module (ECU/ECM) that monitors various sensors located throughout the engine, fuel and exhaust systems, etc.

In an embodiment, at 1304, the dynamically gathered data (or driver behavior data) is transmitted to an insurance evaluation system. In an embodiment, at 1306, the gathered data is analyzed. Such analysis can involve identifying the route taken by the driver, the speed driven, time of day the journey was undertaken, weather conditions during the journey, other road traffic, did the user use their cell phone during the journey?, and the like. In an embodiment, at 1308, the gathered data is assessed from which an insurance rate(s) can be determined. For example, if the driver drove above the speed limit then an appropriate determination could be to increase the insurance premium. In an embodiment, at 1310, the driver can be informed of the newly determined insurance rate. Any suitable device can be employed such as informing the user by cell phone, a display device associated with the on-board monitoring system, or another device associated with the vehicle. The information can be conveyed in a variety of ways, including a text message, a verbal message, graphical presentation, change of light emitting diodes (LED's) on a display unit, a HUD, etc. At 1312, the driver can continue to drive the vehicle whereby the method can return to 1302 where the data gathering is commenced once more.

Alternatively, in an embodiment, at 1312, the driver may complete their journey and data gathering and analysis is completed. In an embodiment, at 1314 the driver can be presented with new insurance rates based upon the data gathered while they were driving the vehicle. The new insurance rates can be delivered and presented to the driver by any suitable means, for example the new insurance rates and any pertinent information can be forwarded and presented to the driver via a HUD employed as part of the real time data gathering system. By employing a HUD instantaneous notifications regarding a change in the driver's insurance policy can be presented while mitigating driver distractions {e.g., line of sight remains substantially unchanged). Alternatively, the on-board monitoring system can be used, or a remote computer/presentation device coupled to the real time data gathering system where the information is forwarded to the driver via, e.g., email. In another embodiment, the driver can access a website, hosted by a respective insurance company, where the driver can view their respective rates/gathered information/analysis system, etc. Further, traditional means of communication such as a letter can be used to forward the insurance information to the driver.

FIG. 8 is a diagram illustrates generally, a method 1400 mounting cameras to capture traffic information, according to embodiments as disclosed herein. In an embodiment, at 1402, the method 1400 includes mounting cameras on the car to monitor the traffic information. For example, the car may include cameras mounted to capture views in the rearward, downward, and the like directions, on the upper surface at the leading end of the front portion thereof. The position for mounting the cameras is not limited to the left side, right side, upper surface, front side, back side, and the like. For example, if the car has a left side steering wheel, the camera may be mounted on a right upper surface at a leading end of the front portion of the car. The cameras may have an angle of view of about 60, 90, 180, and 360 degree. With the construction, since the camera is mounted for a view in the rearward and downward directions on the front portion of the car, it can capture a wide area of the surface of the road in the vicinity of the driver's car, and an area in the vicinity of the left front wheel. Furthermore, the camera can also capture a part of the body of the car in the vicinity of the front wheel. Thereby, the relation between the car and the surface of the road can be recorded. In an example, the cameras can be configured to capture images of the road views including potential collision events such as how close car is following car in front, how often brake is used in period of time, hard brakes count more to reduce driver rating, how frequently does car come close to objects and obstructions (such as trees, cars on the other direction and cars in same direction) while moving.

In an embodiment, at 1404, the method 1400 includes receiving the recorded information from the camera and use image processing techniques to process the information. For example, the system uses image processing techniques to determine potential collision events such as how close car is following car in front, how often brake is used in period of time, hard brakes count more to reduce driver rating, how frequently does car come close to objects and obstructions (such as trees, cars on the other direction and cars in same direction) while moving.

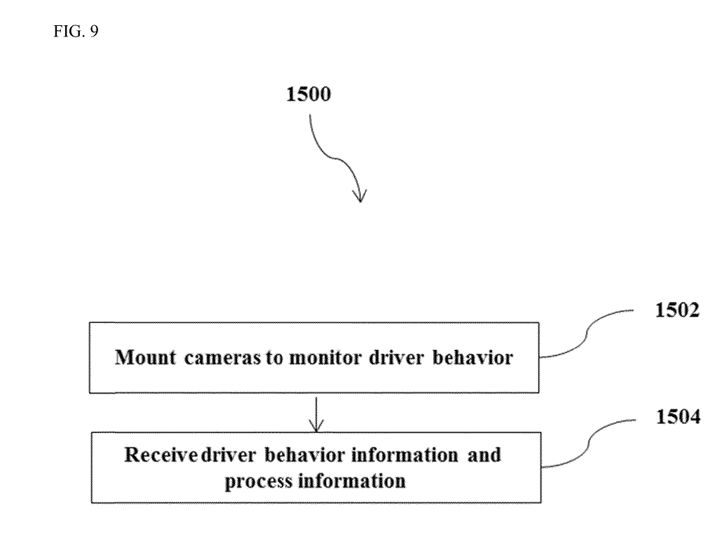

FIG. 9 is a diagram illustrates generally, a method 1500 mounting cameras to capture driver behavior, according to embodiments as disclosed herein. In an embodiment, at 1502, the method 1500 includes mounting cameras on the car to monitor the driver behavior. The position for mounting the cameras is not limited to the left side, right side, upper surface, front side, back side, and the like. The cameras may have an angle of view of about 60, 90, 180, and 360 degree. For example, the camera can capture driver behavior such as for example, but not limited to, images of texting and use of phone while driving, speech of driver shouting or cursing at other drivers or other occupants, indications of intoxication, sleepiness, alcohol level, mood, aggressiveness, and the like. In an embodiment, at 1504, the method 1500 includes receiving the recorded information from the camera and use image processing techniques and voice reorganization techniques to process the information. For example, the system uses image processing techniques to determine the driver activity such as whether the driver is using mobile phone while driving. In another example, the system uses voice recognition techniques to determine the use voice, text, aggressiveness, and the like.

The various actions, units, steps, blocks, or acts described in the methods can be performed in the order presented, in a different order, simultaneously, or a combination thereof. Further, in some embodiments, some of the actions, units, steps, blocks, or acts listed herein may be omitted, added, skipped, or modified without departing from the scope of the invention.

In an embodiment, an early version of recommender systems uses two approaches. The user-centric technique was based almost completely on past driving behaviors. This is not always the best way to predict future activity, particularly in product areas not related to the original sale.

In this regard, the above figures are block diagrams illustrations of methods, systems and program products according to the invention. It will be understood that each block or step of the block diagram and combinations of blocks in the block diagram can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The above described embodiments are set forth by way of example and are not for the purpose of limiting the invention. It will be readily apparent to those skilled in the art that obvious modifications, derivations and variations can be made to the embodiments without departing from the scope of the invention. Accordingly, the claims appended hereto should be read in their full scope including any such modifications,

What is claimed is:

1. An intelligent turn signal control system for a driver, comprising:
a processor;
a positioning system coupled to the processor to provide vehicle position and turn-by-turn command;
an accelerometer coupled to the processor to sense vehicle acceleration;
a turn signal driver interface switch assembly configured to receive driver input to the processor; and
a turn signal lamp actuation circuit configured to connect the processor to a plurality of turn signal lamps, wherein the processor selectively determines whether the turn signal lamp actuation circuit is turned on or off based at least on the positioning system turn-by-turn command and accelerometer output.

2. The system of claim 1, comprising a camera coupled to the processor to a capture street view.

3. The system of claim 2, wherein the processor stores images captured by the camera and uploads the images and location data to a server collecting street view data from a collection of drivers, wherein the server runs code for crowd-sourcing the street views to generate a mapping system.

4. The system of claim 2, wherein the processor detects driver drowsiness using a camera image of the driver.

5. The system of claim 1, comprising a radar coupled to the processor to detect nearby obstacles.

6. The system of claim 1, comprising a gyroscope or a magnetometer coupled to the processor.

7. The system of claim 1, comprising at least one vehicle speed sensor to measure wheel rotation, transmission rotation.

8. The system of claim 1, wherein the processor simultaneously switches left and right turn signals on and off to emulate a hazard function.

9. The system of claim 1, wherein the computer activates the turn signal lamp actuation circuit upon activation of a vehicle anti-lock braking system.

10. The system of claim 1, wherein the processor is programmed to monitor a vehicle cruise control function to determine turn signal operational status.

11. The system of claim 1, wherein the driver interface switch assembly comprises at least one redundant turn signal actuation control disposed on a steering wheel.

12. The system of claim 1, wherein the processor prepares vehicular brakes for a detected turn or an anticipated turn.

13. The system of claim 1, wherein the processor receives travel mutes and sensor data from adjacent vehicles and preparing vehicular brakes for a detected turn or an anticipated turn from adjacent vehicles.

14. The system of claim 1, wherein the processor receives travel routes and sensor data from adjacent vehicles and notifying the driver of a detected turn or an anticipated turn from adjacent vehicles.

15. The system of claim 1, wherein the processor receives travel routes and sensor data from adjacent vehicles and optimizes group vehicular speed to improve fuel efficiency.

16. The system of claim 1, wherein the processor receives travel routes and sensor data from adjacent vehicles and sequences red light(s) to optimize fuel efficiency.

17. The system of claim 1, wherein the processor notifies the driver of driving behaviors from other drivers at a predetermined location.

18. The system of claim 1, wherein the processor switches turn signals and brakes using a predetermined protocol to reduce insurance premium for the driver.

19. The system of claim 1, wherein the processor warns the driver to avoid driving in a predetermined pattern, driving during a predetermined time, driving in a predetermined area, or parking in a predetermined area to reduce insurance premium for the driver.

20. The system of claim 1, wherein the processor sends driver behavior data to an insurer, including at least one of: vehicle speed, vehicle accelerations, vehicle location, seatbelt use, wireless device use, turn signal use, detection of alcohol vapor, driver drowsiness, and time.

21. The system of claim 1, comprising a car-to-car wireless network that communicates travel routes and vehicular data among vehicles traveling in a block.

22. The system of claim 20, wherein the processor sends inter-vehicle driving behavior to the insurer, wherein the inter-vehicle driving behavior includes travel route, vehicle speed, vehicle accelerations, vehicle location, seatbelt use, telephone use, turn signal use, detection of alcohol vapor, driver drowsiness, and time.
